(19) United States
(12) Patent Application Publication
(10) Pub. No.: US 2012/0291433 A1
(43) Pub. Date: Nov. 22, 2012

(54) LOW TEMPERATURE RANKINE CYCLE SOLAR POWER SYSTEM WITH LOW CRITICAL TEMPERATURE HFC OR HC WORKING FLUID

(75) Inventors: Ning Meng, (US); Zhaolute Meng, (US); Zhayate Meng, Edmonton (CA)

(73) Assignee: Ning Meng, Edmonton (CA)

(21) Appl. No.: 13/110,959

(22) Filed: May 19, 2011

(51) Int. Cl. F03G 6/06; F01K 25/08; F24J 2/05; F03G 6/00

(52) U.S. Cl. 60/641.15; 60/641.8; 60/671; 126/652

(57) ABSTRACT

This invention relates to a low temperature solar thermal power system, which combines the solar hot water collectors with the organic Rankine cycle system using the low critical temperature hydrofluorocarbons (HFC) or hydrocarbons (HC) working fluid for converting solar energy to electrical energy. This invention also relates to systems and methodology for conversion of low temperature thermal energy, wherever obtained, to electrical energy using the low critical temperature hydrofluorocarbons (HFC) or hydrocarbons (HC) working fluid for organic Rankine cycle system to drive an electrical generator or do other work in a cost effective way.

### BACKGROUND OF THE INVENTION

The present invention relates to the low temperature Rankine cycle solar power systems using low critical temperature hydrofluorocarbons (HFC) or hydrocarbons (HC) working fluid to produce solar electric power economically, by combining solar hot water collectors with organic Rankine cycle power systems. In particular, the invention relates to the use of low critical temperature HFC or HC refrigerants as the working fluid in for organic Rankine cycle power system powered by low temperature solar thermal energy.

There is a continuing demand for clean renewable energy sources due to the depletion of the earth's supply of fossil fuels and concerns over the contribution to global warming from combustion of fossil fuels.

Solar energy is freely and daily available. It is a clean, non-polluting source of energy. Additionally there is an enormous amount of solar energy provided by the sun to the surface of the earth that is available without significant environmental impact. The amount of solar energy impinging on the earth's surface in 1 h is equivalent to the amount of energy consumed by mankind in 1 year, and amount of solar energy impinging at any particular area is a function of the geographic location, atmospheric conditions and season change. However, for many terrestrial locations, the solar energy impinges on the earth's surface does not require exploration, extraction and refining. However, it must be realized that one of the drawbacks to solar is that half of the earth is in darkness for a very large portion of the daily cycle. Consequently, solar must be combined with a means of energy storage in order for it to be practical.

Some efforts to utilize this energy have been pursued, but with limited success. In one approach, photovoltaic (“PV”) devices made of specialized silicon materials, able to directly convert sunlight into electricity. Though simple and clean, even after years of development, PV devices remain quite expensive and cost prohibitive, resulting in long pay back periods.

Solar thermal electric energy (STE) is another branch of solar energy. STE power is generated using heat from the sun. Solar collectors concentrate the energy of the sun to produce high temperature thermal energy between 400° C. and 800° C., and this thermal energy is converted to electricity using conventional or advanced heat engines. There are three kind of solar thermal electric (STE) technologies: parabolic troughs, power towers, and dish/engine systems. These three kinds of STE technologies depend on the high concentration of solar energy, thus requiring sun concentrating and tracking systems and high levels of direct-normal solar radiation.

These three kinds of solar thermal electric (STE) technologies also use thermodynamic cycle process for converting heat into mechanic or electrical energy. Conventional solar thermal power plants create electricity by using high temperature (over 400° C.) energy, which requires complex devices for concentrating dilute solar energy to concentrated high temperatures solar energy. The cycle processes are operated in this case, for example, on the basis of the classic Rankine cycle with water as its working fluid.

Heretofore, the Rankine cycle has been applied to convert high temperature thermal energy into mechanical or electricity energy in very expensive complex plants comprising steam driven turbines typically operating within a temperature range of 400° C. to 500° C., under very high pressure. Fossil fuels are used to drive boilers, which produce the high temperature, and high pressure steam. Fossil fuel conversion efficiencies of these types of installations may be as high as approximately thirty seven percent (37%). However its high boiling point (100° C.) and high critical temperature (374.3° C.) makes water unattractive for the low temperature solar thermal applications, with very low efficiency.

Therefore, the above-identified solar technologies have failed to provide reliable, low cost, efficient, and variable capacity systems by which solar energy is converted to electrical energy. For these reasons, only a small fraction, currently less than one percent of electricity produced in the world exploits solar energy.

There is a need for solar energy conversion power plants, which are reliable, efficient, cost effective, and size variable to meet both low and high capacity demands for electrical energy.

This invention provides good solutions for cost reduction to produce electricity by using low temperature solar heat, without depending on the complex of sun tracking and concentrating system. The approaches described herein meet that need, which combine the solar hot water collectors with the novel low temperature organic Rankine cycle technology.

The solar hot water collectors are very developed technology and are low cost solar products. There are thousands of solar hot water collector manufactures in the world and over 10 billion dollars market every year. Solar hot water system is economically available to compete with traditional hot water systems like nature gas system and mass production of solar collectors can make the combination of the solar hot water collectors with organic Rankine cycle system economically viable.

There are basically three types of solar thermal collectors that are used for the solar hot water systems: flat-plate, evacuated-tube, and concentrating. All solar hot water systems can produce hot water with a temperature about 60° C. or somewhat lower.

Flat-Plate collectors comprise of an insulated, weatherproof box containing a dark absorber plate under one or more transparent or translucent covers. Water or heat conducting fluid passes through pipes located below the absorber plate. As the fluid flows through the pipes it is being heated. This style of collector, although inferior in many ways to evacuated tube collectors, is still the most inexpensive type of collector for solar hot water systems. But at the temperature range over 60° C., the thermal collecting efficiency of flat-plate collectors is very low due to the large heat loss.

Evacuated Tube solar water collectors are made up of rows of parallel glass tubes. There are several types of evacuated tubes (sometimes also referred to as Solar Tubes).

Type 1 (Glass-Glass) tubes consist of two glass tubes, which are fused together at one end. The inner tube is coated with a selective surface material that absorbs solar energy well but inhibits radiative heat loss. The air is withdrawn (“evacuated”) from the space between the two glass tubes to form a vacuum, which eliminates conductive and convective heat loss. Glass-glass solar tubes may be used in a number of different configurations, including direct flow, heat pipe, and U pipe.

Type 2 (Glass-Glass-water flow path) tubes incorporate a water flow path into the tube itself. The problem with these tubes is that if a tube is ever damaged, water will pour from the collector and the collector has to be shutdown and the tube replacement is required.

Type 3 (Glass-Glass heat pipe) tubes incorporate a heat transfer liquid into the inner glass tube itself as the function of heat pipe. This kind of tube performs better in overcast conditions and low temperature environments and is the one inexpensive type of collector for solar hot water systems.

Type 4 (Metal-Glass) tubes consist of a single glass tube. Inside the glass tube is a flat or curved aluminum plate, which is attached to a copper heat pipe or water flow pipe. The aluminum plate is generally coated with Tinox, or similar selective coating. These tubes perform very well in overcast conditions and very low temperature environments. At high temperature about 80° C., only metal-glass tubes collectors are able to achieve a thermal efficiency high than 70%. Insulation temperature of metal-glass evacuated tubes can reach 200° C. from solar, average heat efficiency can still be more than 50%; even in an environment of below −50° C. These types of tubes are very efficient in solar heat collecting and most suitable for organic Rankine cycle system applications.

For heat sources with low temperatures, a wide diversity of technologies has been developed over recent years, which make it possible to convert low temperature heat into mechanical or electrical energy. A process known as organic Rankine cycle (ORC) with low boiling point organic working fluid stands out. Various organic Rankine cycles for different applications between 100° C. and 352° C. have been developed on the basis of the ORC with different working fluids.

The organic Rankine cycle (ORC) is a promising system for conversion of low and medium temperature heat to electricity. The ORC power system works like a Rankine steam power plant, but uses a low boiling point organic working fluid instead of water. A certain challenge is the choice of the organic working fluid and of the particular design of the cycle. The systems still need to improve the efficiency when using low temperature heat source. Moreover, the working fluid also has to fulfill the safety criteria, be environmental friendly, and low cost for a power plant.

The Organic Rankine cycle (ORC) is a vapor power cycle with an organic fluid as the working fluid. Functionally, it resembles the steam cycle power plant: a pump increases the pressure of condensed liquid working fluid, this liquid is vaporized in an evaporator/boiler by extracting heat, the high pressure working fluid vapor expands in a turbine, producing power, and the low pressure vapor leaving the turbine is condensed in a condenser before being sent back to the pump to restart the cycle.

The efficiency of the ORC system is depending on the temperature difference between the temperature of condensation (temperature of the surrounding) and the reachable temperature of vaporization. But the types of working fluids also have a big impact on the efficiency of an organic Rankine cycle system. Many types of working fluids have been used in organic Rankine cycle turbine in the past, including various refrigerants and hydrocarbons. The efficiency of the ORC-process can reach nearly 10% at a temperature of 100° C. and nearly 20% at a temperature of 150° C. Various refrigerants and hydrocarbons as their working fluid have been utilized for various cycles for different applications between 100° C. and 352° C.

For low temperature solar power applications, U.S. Pat. No. 7,340,899 to Jeffrey discloses a low efficiency solar air motor generator system with the HCFC refrigerant wherein the solar energy collector is constructed from a plurality of heat exchanger of the kind used as evaporator in automobile air conditioners. Another U.S. Pat. No. 4,103,493 to James L discloses a low efficiency apparatus comprising in combination, a direct boil solar collector, which boils a refrigerant therein, a Ranking cycle engine for converting heat energy to kinetic energy with chlorine containing working fluids. However, both of the patents could not choose the high efficiency, and environmental friendly working fluid for the solar energy applications. Their working fluids remain the concerns on low ozone depletion potential and low efficiency.

Therefore, it is impossible to combine conventional ORC system with the solar hot water collectors with better efficiency, because the temperature of the heat source collected by a solar hot water system is too low. Thus there is a need to improve the ORC working fluids and systems for producing electricity from the low temperature of solar heat source between 40° C. to 100° C. with better efficiency and low cost. The approaches described herein meet that need, which combines a solar hot water system with the low critical temperature HFC or HC working fluid organic Rankine cycle technology to produce electricity with high efficiency and low cost. Providing a reliable, long-term, cost effective, and efficient way of using sunlight to obtain electrical power that has long been an unsolved problem, until the present invention. This invention makes it possible to solve this problem.

### SUMMARY OF THE INVENTION

In brief summary, the present invention overcomes or substantially alleviates long term problems of the prior art by which solar energy is cost effectively converted to electrical energy. The present invention also provides the method and device for conversion of low temperature thermal energy, wherever obtained, to electrical energy using a novel organic Rankine cycle system to drive an electrical generator, in a cost effective way. The novel organic Rankine cycle system can do other work as well. The present invention provides reliable, cost effective ways for conversion of solar energy and thermal energy to electricity, where the size of the system can be correlated to the desired capacity.

With the foregoing in mind, it is a primary object of the present invention to overcome or substantially alleviate long term problems of the prior art by which solar energy is converted to thermal energy and the thermal energy is thereafter, converted to electrical energy.

Another paramount object of the present invention is to provide reliable, cost effective systems and methods for conversion of solar energy to electricity and thermal energy and to thereafter, use the thermal energy to create additional electricity or do other work, where the size of any such system can be correlated to a desired capacity.

Another important object is to provide systems and methods for the conversion of low temperature thermal energy, wherever obtained, to electrical energy or do other work using a novel organic Rankine cycle system by which a generator is driven or another work performing mechanism is driven, in a cost effective way.

It is a further valuable object to provide the novel working fluids for organic Rankine cycle system and related methodology.

It has been discovered by this invention, that some low critical temperature working fluids have unique low temperature applications as a working fluid in an organic Rankine cycle system. One example of preferred working fluids is hydrofluorocarbons (HFC) or hydrocarbons (HC), which have low critical temperature (LCT), and low boiling point (LBT). The present invention provides hydrofluorocarbons (HFC) or hydrocarbons (HC) as the organic Rankine cycle working fluid for this low temperature solar power system.

These objects and features of the present invention will be apparent from the detailed description taken with reference to accompanying drawings.

### BRIEF DESCRIPTION OF THE DRAWINGS

FIG. 1 is a schematic illustration of the low temperature organic Rankine cycle solar power system including the solar hot water collectors and the ORC power system with the low critical temperature HFC or HC working fluid.

FIG. 2a is a temperature-entropy (T-S) diagram for R32, a working fluid used in the low temperature organic Rankine cycle solar power system.

FIG. 2b is another temperature-entropy (T-S) diagram for R32, a working fluid used in the low temperature organic Rankine cycle solar power system for cold climate.

FIG. 3 is a temperature-latent heat diagram for R32, as a working fluid used in the low temperature organic Rankine cycle solar power system.

FIG. 4 is a temperature-saturated pressure diagram for R32, as a working fluid used in the low temperature organic Rankine cycle solar power system.

FIG. 5 is a condense temperature-ORC system efficiency diagram for R32, as a working fluid used in the low temperature organic Rankine cycle solar power system.

FIG. 6 is an evaporation temperature-ORC system efficiency diagram for R32, as a working fluid used in the low temperature organic Rankine cycle solar power system.

FIG. 7a is another temperature-entropy (T-S) diagram for R41; a working fluid is used in the low temperature organic Rankine cycle solar power system for cold winter for cold climate.

FIG. 7b is another temperature-entropy (T-S) diagram for R41, a working fluid is used in the low temperature organic Rankine cycle solar power system for super critical applications.

FIG. 8 is a condense temperature-ORC system efficiency diagram for R41, as a working fluid is used in the low temperature organic Rankine cycle solar power system.

FIG. 9 is a schematic illustration of the low temperature directs heating solar power system, including the solar direct heating system and the low critical temperature HFC or HC working fluid ORC power system.

FIG. 10 is a view of the solar collector utilized in this invention.

FIG. 11 is a detailed view of the metal-glass evacuated tube utilized in this invention.

FIG. 12 is a detailed view of direct heating solar collector, full vacuum tube with concentric double-pipe collector utilized in this invention.

### DETAILED DESCRIPTION OF THE INVENTION

The present invention utilizes, in some forms, the free and limitless energy of the sun to produce thermal energy and electricity. The scale of commercial installations of the present invention can be tailored to the need, ranging from small stand alone systems for residential and small business use to intermediate sized plants for plant or factory use to massive assemblies design to supplement the supply of electricity or to mitigate against if not, eliminate an electrical energy crisis, such as the recent one in Japan. The present invention is economical to install and maintain, and is reliable and not maintenance-intensive, and is efficient and cost effective to operate and does not pollute the environment.

Using the present invention, businesses, industrial plants, retail and office buildings, homes, farms and villages can produce their own electrical power, and avoid one of the large costs of doing business today, the ever-escalating price of purchased electrical power generated from fossil and nuclear fuels.

This invention is capable of making significantly more energy per square meter than conventional solar technologies. Prior art, the solar thermal collectors are incapable of converting the low temperature solar thermal energy to electricity generating systems, but in present invention, even the flat plate solar collectors can be used to convert electrical energy as well.

The present invention is a better choice, which can be scaled or sized to independently produce as much electrical energy as needed on site, such as the energy needed to power a home or business, pump water, irrigate land and run remote communication installations.

Unlike centralized forms of power generations, de-centralized use of on-site solar obtained electrical power needs no far-flung distribution network of gigantic towers and high voltage lines, instead it utilizes a universally available asset, sunshine.

The cost of the generating equipment itself used in the production of power for a building can be amortized over the life of the building, as part of debt financing (mortgage). Amazing, as it may seem, one of the largest and most uncontrollable costs a building owner faces is the ever escalating cost of electrical power. Using the present invention, one actually has the ability to eliminate the cost of purchased electrical power now and for years to come.

When land and water were plentiful and labor was cheap, little was known about the delicate balance existing between the environment and the extraction, burning, wasting of non-renewable fuels. Now it is all too apparent that our supply of fossil fuels is limited and that these sources are causing damage to our atmosphere, water supplies, and food chain damage that is or may soon become irreversible. The costs, too, for fossil fuels to continue upward as the more accessible fuel deposits are consumed, and as the costs for machinery, labor, and transportation continue to rise around the world.

Ironically, the best answer to the world's need for energy has always been the sun. The sun can satisfy a significant percentage of our energy requirements while helping us to become independent of the negative aspects inherent in conventional electrical power generation. Switching to solar-derived electrical power will reduce the pollution produced by coal, oil and nuclear fuels. It will also slow the use of coal and oil and allow us to conserve these resources for later and perhaps valuable uses. Harnessing the sun will also reduce, or eliminate the need for nuclear power and mitigate its many risks and problems.

Even though the sun is just beginning to contribute to satisfying the world's energy demands on a large scale, direct sunlight has been powering satellites and spacecraft since 1958. In the 1970's, the first terrestrially directed sunlight photovoltaic devices supplied power to locations too remote to have ties to utility lines. Then, as the solar industry developed more efficient silicon cells and generators, larger grid-connected direct sunlight installations become more and more practical.

The present invention is not space-intensive. The present invention, in some forms, can be mounted on an existing rooftop so that it essentially takes up no additional space at all. Ground-mounted systems on a pad or superimposed above a parking lot are also options as well. Column mounting is a further option.

Various embodiments of the present invention may be used in conjunction with residences, office buildings, manufacturing facilities, apartment buildings, schools, hospitals, remote communications, telemetry facilities, offshore platforms, water pumping stations, desalination systems, disinfection systems, wilderness camping, headquarters installations, remote medical facilities, refrigeration systems farms and dairies, remote villages, weather stations, and air conditioning systems.

The present invention is also useful: in (a) providing catholic protection against galvanite corrosion, (b) storage of electrical energy in batteries, in some circumstances and (c) generation and sale of electricity to utility companies.

A low temperature organic Rankine cycle solar power system is invented by combining low cost solar hot water collectors with a high efficiency ORC system. More specifically, instead of custom components and devices that incorporate exotic materials for collecting solar thermal energy, this invention combines high efficiency and less expensive solar hot water collectors with a high efficiency ORC system to make the solar power system economically viable.

Theoretically, different types of solar collectors have a significant impact on the efficiency of an organic Rankine cycle system, and primarily on the operating temperatures and pressures of the cycle. In the past, many types of solar collectors have been used to collect solar thermal energy efficiently for the solar hot water system under 60° C. At a temperature over 80° C., which is the need for this ORC system, only metal-glass evacuated tubes are able to achieve a high thermal efficiency than 70% and then match the high efficiency need of organic Rankine cycle. Insulation temperature of metal-glass evacuated tubes even can reach 200° C. from solar, and average heat efficiency can still be more than 50%; even in an environment below −50° C.

Types of working fluids of the ORC system also have a big impact on the efficiency of an organic Rankine cycle system for the various thermodynamic cycles in which the turbine operates. Many types of working fluids have been used in organic Rankine cycle turbine in the past, including various refrigerants and hydrocarbons. The selection of the working fluid will depend on the range of solar heat temperature and heat sink temperature of a condenser in a closed loop of the ORC system. In the present invention, the low critical temperature hydrofluorocarbons (HFC) or hydrocarbons (HC) are selected as the working fluid to be used in the closed loop of the ORC system, with the HFC or HC working fluids critical temperature in the range of 20-100° C., relating to solar heat temperature range of 40-100° C., and a heat sink temperature of a condenser ranging from −20 to 20° C.

The selection of the working fluid is a key importance in a low temperature Rankine cycle system. In order to recover low-grade solar heat, the working fluid must have a lower boiling temperature. A fluid with a low latent heat will have high efficiency, as it ejects less heat energy to the condenser and thus reduces the required heat, as the results, reduces the cost, for reducing the flow rate, the size of the solar facility, and the pump consumption. The freezing point of the selected working fluid should be lower than the lowest temperature in the cycle and also has a low environmental impact.

Conventionally, the organic Rankine cycle (ORC) is a very developed process for conversion low and medium temperature heat to electricity from a temperature range of 80° C.-352° C. But there is no ORC system for conversion low temperature heat to electricity from a temperature range of 30° C.-80° C.

The present invention uses the low critical temperature hydrofluorocarbons (HFC) or hydrocarbons (HC) working fluids in the critical temperature range of 20-100° C., as its working fluid of an ORC for low temperature solar power system. Some suitable low critical temperature hydrofluorocarbons (HFC) or hydrocarbons (HC) working fluids include, but are not necessarily limited to:

R23, Fluoroform (CHF3)

R32, Methylene fluoride (CH2F2)

R41, Methyl fluoride (CH3F)

R116, Perfluoroethane (CF3CF3)

R125, CHF2CF3

R134a, CH2FCF3

R143a, CH3CF3

R152a, CHF2CH3

R218, Perfluoropropane (CF3CF2CF3)

R227ea, CF3CHFCF3

R236ea, CF3CHFCHF2

R236fa, CF3CH2CF3

RC318, C4F8

R404A

R407A

R407B

R407C

R407D

R407E

R410A

R410B

R413A

R417A

R419A

R421A

R421B

R422A

R422B

R422C

R422D

R423A

R424A

R425A

R427A

R428A

R507A

R1150, Ethylene (CH2CH2)

R170, Ethane (CH3CH3)

R1270, Propylene (CH3CH2CH2)

R290, Propane (CH3CH2CH3)

Before R245fa have been utilized for the lowest temperature applications of conventional ORC system. The properties comparing of saturated pressure between the low critical temperature hydrofluorocarbons (HFC) or hydrocarbons (HC) working fluids and R245fa is showed in table 1. The low critical temperature hydrofluorocarbons (HFC) or hydrocarbons (HC) working fluids ORC system is able to achieve a high efficiency even at a very low temperature between of 30° C.-100° C., due to its low boiling point, low critical temperature, and small latent heat characteristic. At low temperature of 30° C.-100° C., the low critical temperature hydrofluorocarbons (HFC) or hydrocarbons (HC) working fluids have much high saturated pressure than R245fa. This is the reason that the low critical temperature hydrofluorocarbons (HFC) or hydrocarbons (HC) working fluids can make more mechanical power than R245fa at this low temperature, and consequently the efficiency of ORC with the low critical temperature hydrofluorocarbons (HFC) or hydrocarbons (HC) working fluids are much higher than R245fa ORC. Present invention addresses the working fluid with low critical temperature, and higher critical pressure at the operating temperature area.

TABLE 1
Saturated pressure comparison of the low critical temperature HFC and R245fa

| | | | | | | 20° C. |
|---|---|---|---|---|---|---|
| | | Critical | Critical | Boiling | Latent heat | Saturate |
| Working | Chemical | temperature | pressure | temperature | at 20° C. | pressure |
| fluid | formula | ° C. | MPa | ° C. | KJ/mol | MPa |
| R245fa | CHF2CH2CF3 | 154 | 3.65 | 15.1 | 25.9 | 0.12 |
| R23 | CHF3 | 26.1 | 4.83 | −82.0 | 5.3 | 4.16 |
| R32 | CH2F2 | 78.1 | 5.78 | −51.7 | 14.6 | 1.45 |
| R41 | CH3F | 44.1 | 5.90 | −78.3 | 8.7 | 3.40 |
| R116 | CF3CF3 | 19.9 | 3.05 | −78.1 | 0 | 3.04 |
| R125 | CHF2CF3 | 66.0 | 3.62 | −48.1 | 13.8 | 1.20 |
| R134a | CH2FCF3 | 71.2 | 4.06 | −26.1 | 18.6 | 0.57 |
| R143a | CH3CF3 | 72.7 | 3.76 | −47.2 | 13.9 | 1.10 |
| R1150 | CH2CH2 | 9.2 | 5.04 | −103.8 | 0 | 5.41 |
| R170 | CH3CH3 | 32.2 | 4.87 | −88.6 | 6.2 | 3.76 |
| R1270 | CH3CH2CH2 | 92.4 | 4.66 | −47.7 | 14.5 | 1.01 |
| R290 | CH3CH2CH3 | 96.7 | 4.25 | −42.1 | 15.2 | 0.83 |

An additional advantage using low critical temperature hydrofluorocarbons (HFC) or hydrocarbons (HC) as working fluid is the alternative use of the supercritical region for the heat transfer, this is because their easy thermodynamic terms for the heat exchange by using low temperature heat. That is caused by relatively high values of the heat capacity, low values of the viscosity, and heat conductivity comparable to steam. Another advantage to the low critical temperature hydrofluorocarbons (HFC) or hydrocarbons (HC) working fluid OCR system is given by the fact that the heat transfer and working fluid can be same; the low critical temperature hydrofluorocarbons (HFC) or hydrocarbons (HC) working fluid can be used for both tasks. The fluid is working in one closed circuit loop and an additional evaporator or heat exchanger is not needed.

Other advantages of this working fluid are given by its relatively low danger potential for people, and environment and its high availability. Compared with these working fluids, the low critical temperature hydrofluorocarbons (HFC) or hydrocarbons (HC) working fluids have many advantages. It is inexpensive, non-explosive, most non-flammable. In addition, it has no ozone depleting potential (ODP) and low global warming potential (GWP). Due to its relatively high working pressure, the low critical temperature hydrofluorocarbons (HFC) or hydrocarbons (HC) working fluid ORC system is more compact than the system operating with other working fluids.

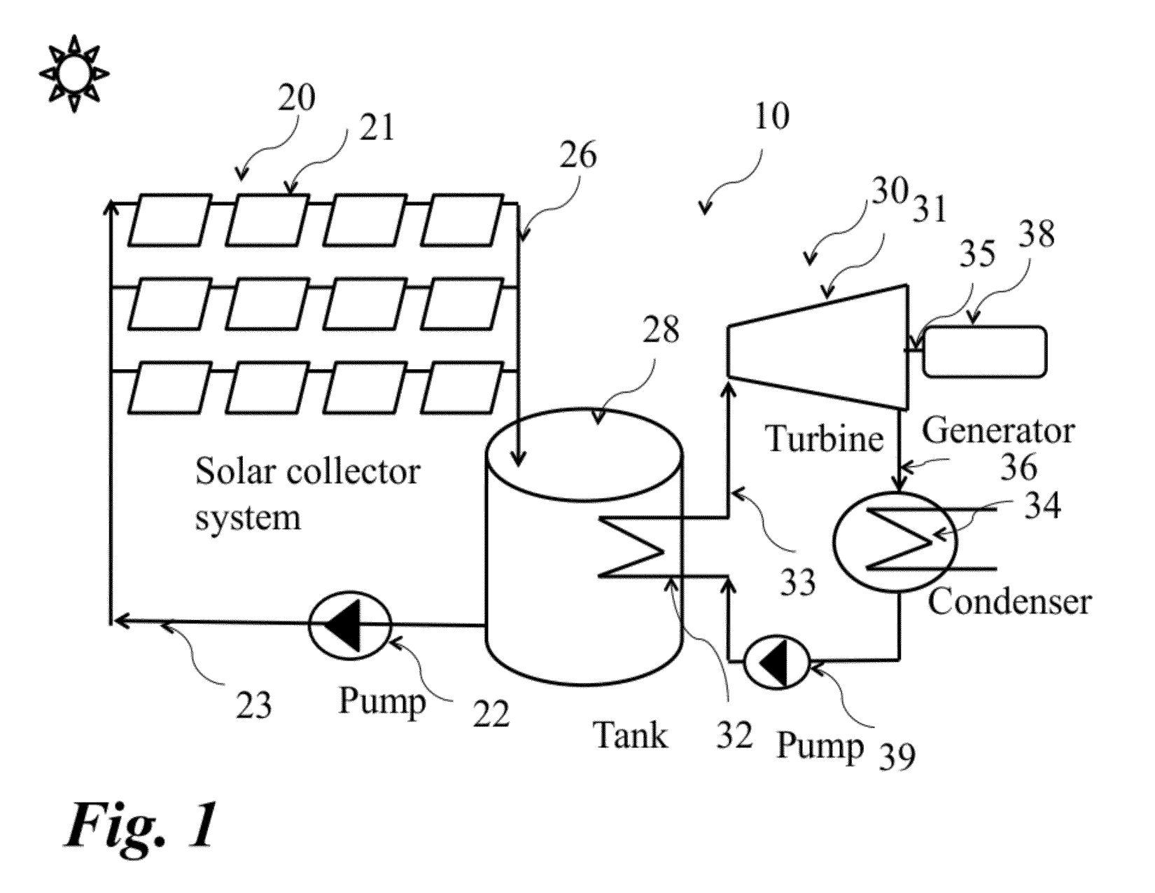

FIG. 1 shows a schematic of the low temperature solar power system 10, which generally includes solar hot water collectors 20 and an organic Rankine cycle system 30. The solar hot water collectors generally includes plenty of solar collectors 21, a cycle pump 22; a storage tank 28 with coil heat exchanger 32, a expansion tank, and plenty of circulation pipes 23 and heat transfer fluid in the first loop 23. The ORC system 30 generally includes a cycle pump 39; an evaporator 32, a turbine 31, a turbine generator 38, a condenser 34, and circulation pipes 33 and 36. In addition, generator 38 and turbine 31 are connected on a shaft 35. The working fluid is pumped and circulated in the second closed loop 33 and 36 of ORC system. A solar hot storage tank 28 is used to provide thermal energy to organic Rankine cycle system 30 up to 24 hours a day. The power generated by generator 38 may be used in various applications, including, but not limited to: powering commercial and residential buildings.

This low temperature organic Rankine cycle solar power system 10 uses two loops to convert solar energy into electrical power. A first loop 20 of the solar hot water collectors heats a heat transfer fluid, which can be a liquid as water. The heat transfer fluid can include at least one of: water, a water-base mixture or solution, an anti-frozen agent, ethylene glycol, and high temperature oil fluids, which are fluid that can remain in liquid form at temperature above the boiling point of water. High temperature fluids also include silicon oil. The first loop 20 is referred to herein as a heating loop. A second loop 30 of the ORC system producing electrical power, and is sometimes referred to herein as the working fluid loop. The first loop 20 exchanges the solar heat with the second loop 30 in the evaporator 32.

In the operation of solar hot water system 20 in the first loop, the heat transfer fluid is pumped through the pump 22 to solar collectors 21 from the storage tank 28. The heat transfer fluid flows through solar collectors 21 where it is heated by the solar energy. Solar collectors 21 are capable of withstanding temperatures of at least approximately 250° C. After the heat transfer fluid is heated in the solar collectors 21 to the desired temperature, the heat transfer fluid flows into hot thermal storage tank 28. The heat energy is then stored in the hot thermal storage tank 28 until it is needed by ORC system 30 to produce electricity. Hot thermal storage tank 28 allows for power production during cloudiness or darkness. The heat transfer fluid using for this solar thermal system can be any fluid that has the capability to transfer heat and thermally maintain the heat in the fluid, such as silicon oil, water, antifreeze mixture. In an exemplary embodiment, glycol antifreeze mixture is used as the heat transfer fluid through solar heating system 20.

In the operation of second loop 30, when electricity generation is needed, the low critical temperature hydrofluorocarbons (HFC) or hydrocarbons (HC) working fluid is pumped through the heat exchanger of the thermal storage tank 28 to a high working pressure, heated induce a phase change in the heat exchanger from a liquid phase to a gas phase, and flow to the turbine 31. The turbine 31 is rotated by the expansion of the high pressure HFC or HC gas. The electrical generator 38 is coupled to the turbine so that rotation of the turbine 31 causes rotation of the generator 38 to make electricity. The high pressure HFC or HC working fluid gas is expanded and released the high-pressure energy, thus reducing the temperature of the working fluid gas. The pressure energy released during the expansion process in turbine 31 is sufficient to turn the generator 38 with shaft 35. Generator 38 uses the mechanical energy from the turbine 31 to generate electricity. The low pressure HFC or HC vapor leaving the turbine is condensed in the condenser 34 to induce a phase change from a gas phase to a liquid phase, before being sent back to the pump to restart the cycle. Condenser 34 may reject the heat into water, which is sent to a cooling tower to release the heat to the atmosphere. Alternatively, the heat rejection may also be accomplished by direct air cooling.

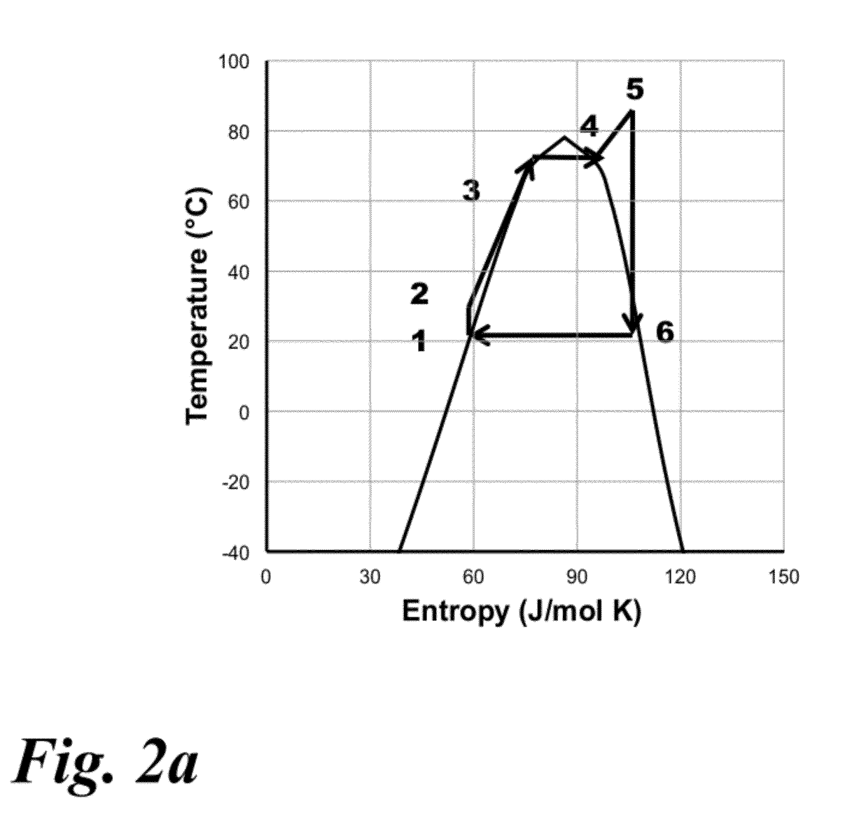

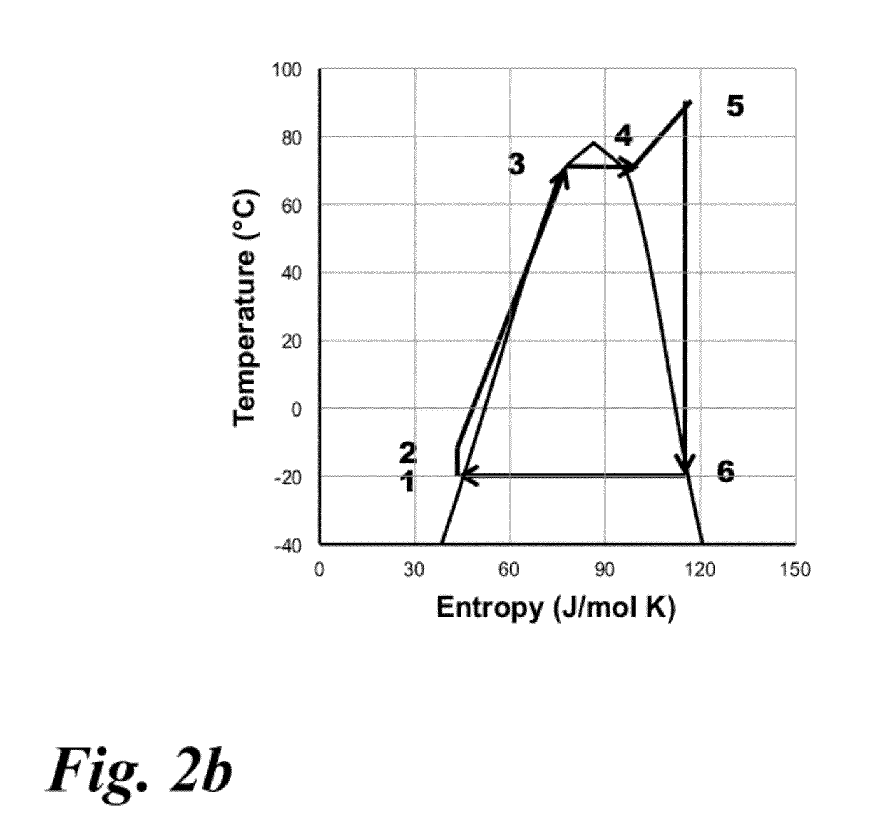

FIG. 2a is a temperature-entropy (T-S) diagram of exemplary embodiment using R32 as working fluid of ORC system 30. The R32 working fluid is pumped from state point 1 to point 2 increasing the pressure, and preheating to approximately 75° C. from state point 2 to point 3, thus evaporating to approximately 53.4 atm from state point 3 to point 4 in the thermal storage tank 28, and overheated from state point 4 to point 5. At turbine 31, the high pressure R32 gas is allowed to expand and release heat energy to produce power, reducing the temperature of the R32 gas to approximately 20° C. from state point 5 to point 6 to the pressure approximately 14.5 atm. The R32 vapor is condensed for rejecting the latent heat from state point 6 to point 1, and then changes its vapor phase back to liquid phase. In this exemplary embodiment, the efficiency of the R32 working fluid ORC system 30 is approximately 19.5%.

FIG. 2b is a temperature-entropy (T-S) diagram of R32 ORC system 30 for cold climate. The R32 working fluid is pumped from state point 1 to point 2 increasing the pressure, and preheating to approximately 75° C. from state point 2 to point 3, thus evaporating to approximately 53.4 atm from state point 3 to point 4 in the thermal storage tank 28, and overheated from state point 4 to point 5. At turbine 31, the high pressure R32 gas is allowed to expand and release heat energy to produce power, reducing the temperature of the R32 gas to approximately −20° C. from state point 5 to point 6 to the pressure approximately 4.0 atm. From state point 6 to point 1, the R32 vapor is condensed for rejecting the latent heat, and then changes its vapor phase back to liquid phase. In this exemplary embodiment, the efficiency of the R32 ORC system 30 is approximately 27%. This temperature-entropy (T-S) diagram indicated the low critical temperature HFC or HC working fluid is best suited for using in the very cold climate to get high efficiency.

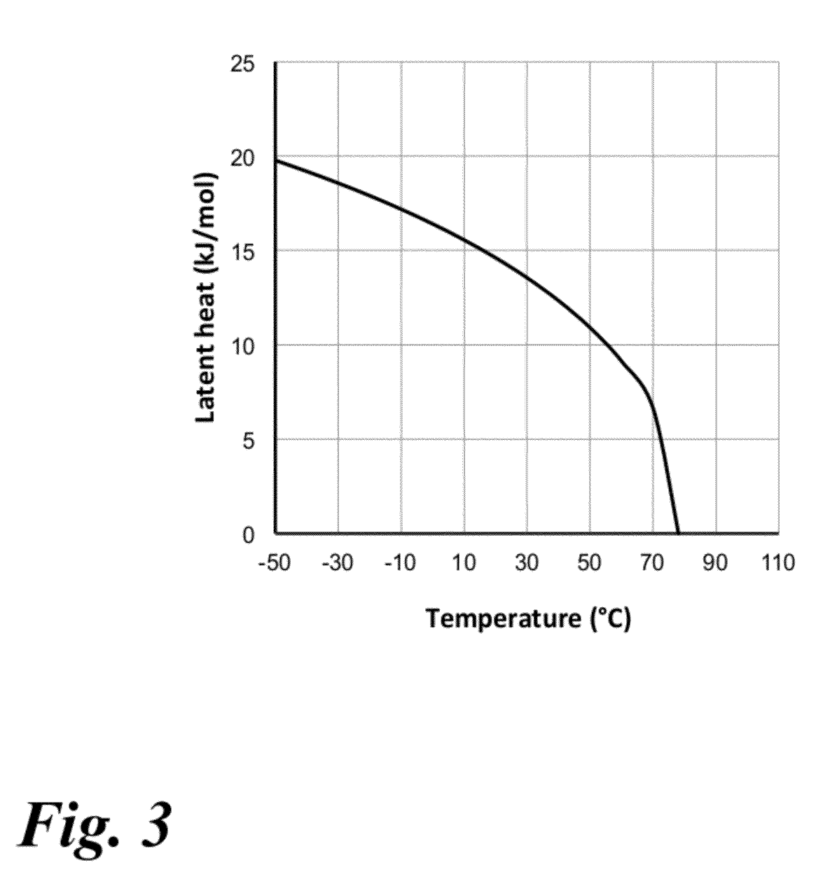

FIG. 3 is a plot of the R32 working fluid latent heat-temperature diagram, illustrating thermal characteristic of the R32 working fluid ORC system 30. The R32 working fluid has very low latent heat, which is suited for high efficiency of the low temperature applications. For example, at the condense temperature of 20° C., the R32 latent heat is only 14.6 KJ/mol, much small than water latent heat (40.68 KJ/mol) of water; consequently the R32 ORC system 30 will have a higher efficiency than water Rankine cycle for rejecting less energy in condenser 34.

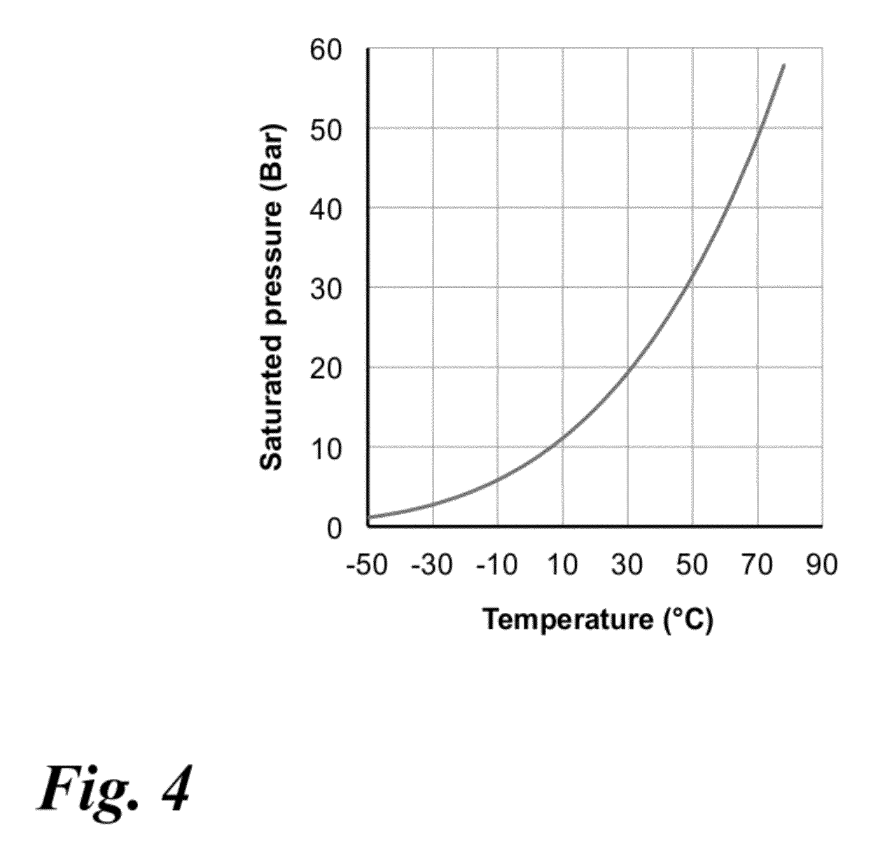

FIG. 4 is a R32 working fluid saturated pressure-temperature diagram. Comparing the boiling temperature (100° C.) of water, R32 working fluid has a very low boiling temperature (−51.7° C.), a low critical temperature (78.1° C.) and very high critical pressure (57.8 atm); suggesting that the low critical temperature R32 working fluid ORC system 30 can have a very high operating pressure even at a low operating temperature. For the exemplary embodiment, at the evaporating temperature 75° C., the R32 saturated pressure is 53.4 atm, and at the condensing temperature 20° C., the R32 saturated pressure is 14.5 atm, the pressure difference is 38.9 atm between two temperatures, much higher than other conventional ORC systems. For a turbine system, the pressure difference between the evaporating pressure and condenser pressure is very important to rotary the turbine for mechanical work. This is another reason why low critical temperature HFC or HC working fluid is the most suitable working fluid for low temperature solar power system 10.

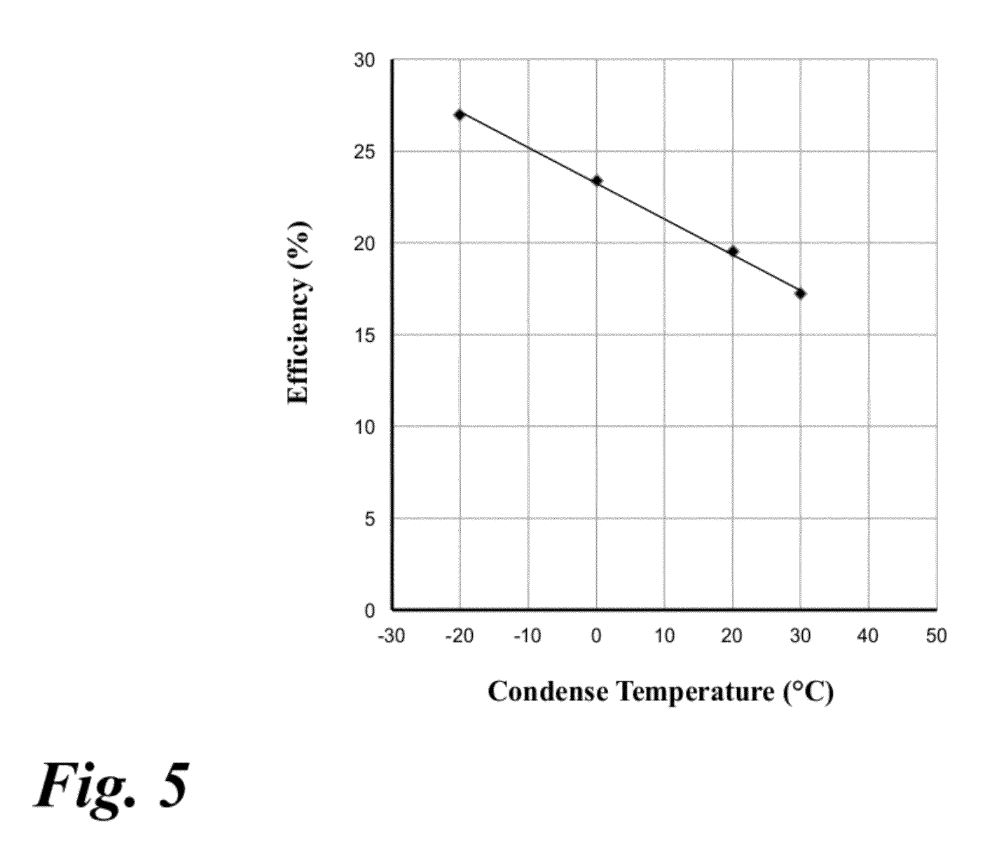

FIG. 5 is variations of the efficiency of R32 working fluid ORC system 30 as a function of condense temperature, with the same evaporation temperature 75° C. The cycle efficiency of the R32 ORC system 30 depends on the temperature of rejection in the condenser 34. The efficiency is 19.5% at the normal condense temperature (20° C.); while at the cold condense temperature (−20° C.), the efficiency will increase to 27%. It has been known that when the heat rejection is accomplished by direct air cooling in the low critical temperature hydrofluorocarbons (HFC) or hydrocarbons (HC) working fluid ORC system 30, more high efficiency is able to achieve at cold climate.

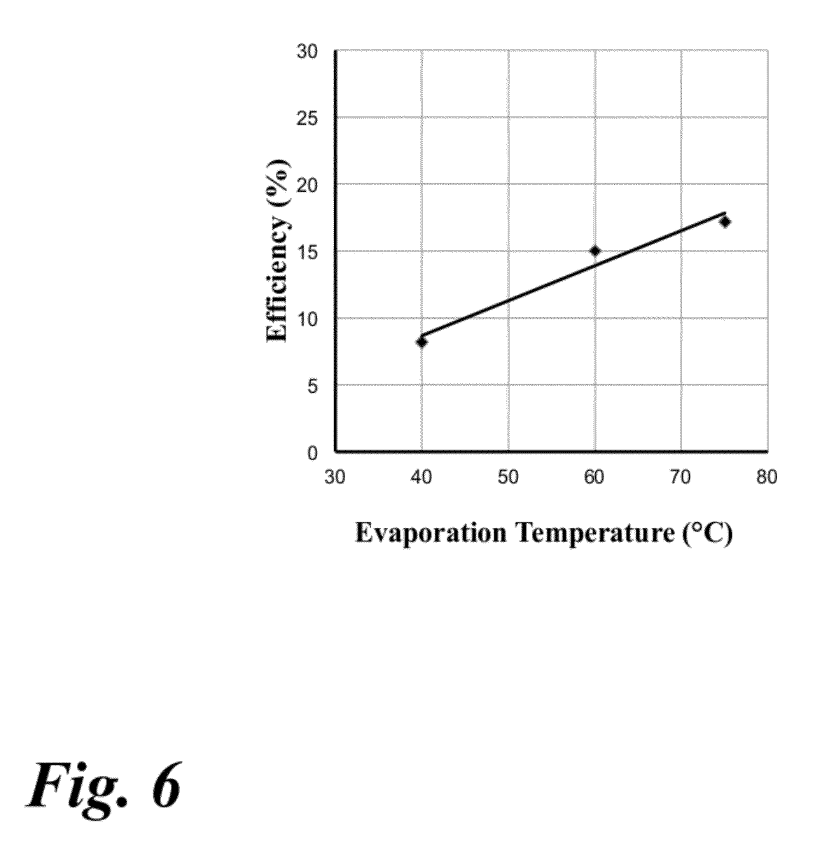

FIG. 6 is a plot of efficiency of the R32 working fluid ORC system 30 versus evaporation temperature, with the same condenses temperature 20° C. The cycle efficiency of the R32 ORC system 30 depends on the temperature of evaporation. At the low temperature (40° C.); the efficiency of this ORC system 30 is 8.2%, and increases to 17.2% at the evaporation temperature 75° C. This confirms that the metal-glass solar collector is suitable to achieve a high efficiency of this ORC system.

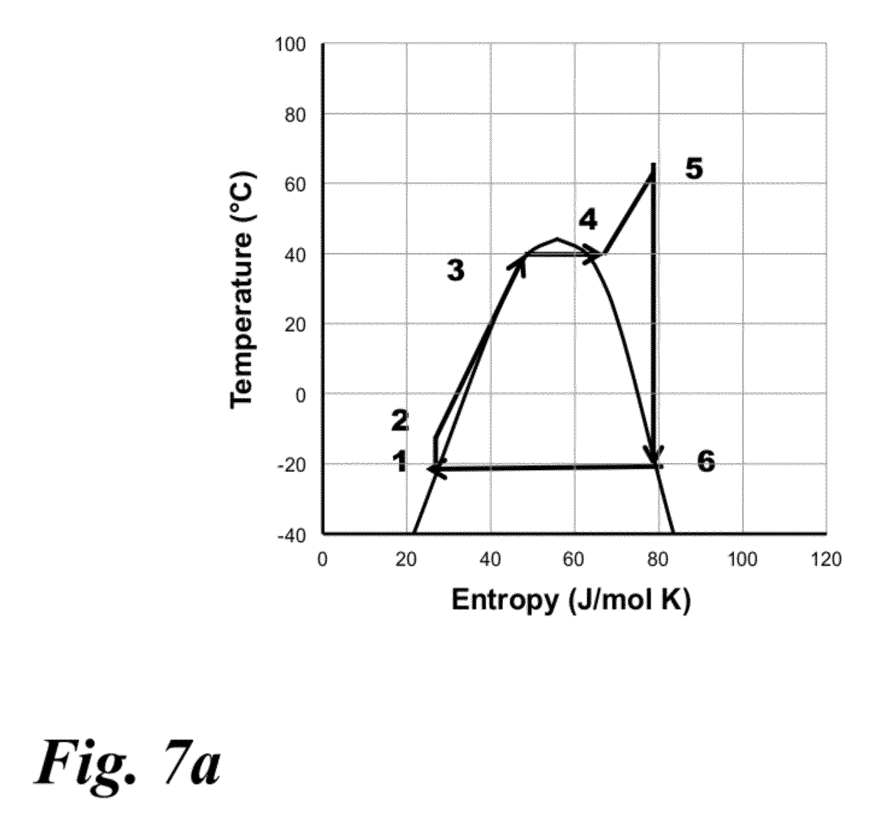

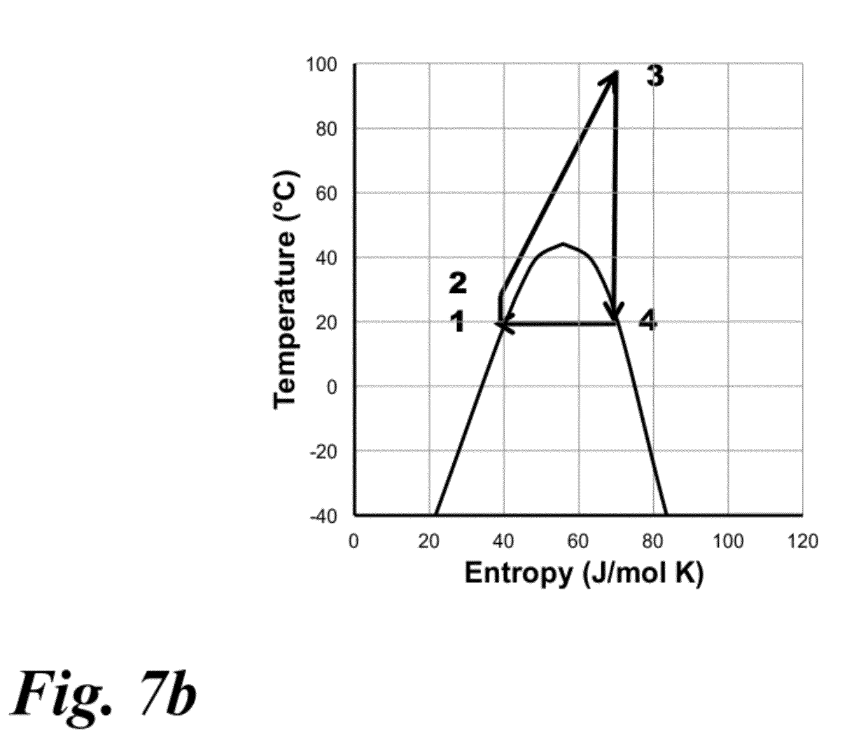

FIG. 7a is a temperature-entropy (T-S) diagram of another exemplary embodiment using R41 as working fluid of ORC system 30. The R41 working fluid is pumped from state point 1 to point 2 increasing to the desired pressure, and preheating to 40° C. from state point 2 to point 3, thus evaporating with approximately 53.8 atm from state point 3 to point 4 in the thermal storage tank 28, and overheated from state point 4 to point 5. At turbine 31, the high pressure the R41 gas is allowed to expand and release heat energy to produce power, reducing the temperature of the R41 gas to approximately −20° C. from state point 5 to point 6 to the pressure 11.4 atm. The R41 vapor is condensed for rejecting the latent heat from state point 6 to point 1, and then changes its vapor phase back to liquid phase. In this exemplary embodiment, the efficiency of the R41 working fluid ORC system 30 is approximately 23%. This temperature-entropy (T-S) diagram of this exemplary system indicated the lower critical temperature hydrofluorocarbons (HFC) or hydrocarbons (HC) working fluid is best suited for using in very cold climate to get high efficiency.

FIG. 7b is a temperature-entropy (T-S) diagram of R41 supercritical ORC system 30. The R32 liquid is pumped from state point 1 to point 2 increasing the pressure to supercritical pressure, and preheating to supercritical temperature from state point 2 to point 3. At turbine 31, the high pressure R41 gas is allowed to expand and release heat energy to produce power, reducing the temperature of the R41 gas to approximately 20° C. from state point 3 to point 4 to the pressure approximately 34 atm. The R41 vapor is condensed for rejecting the latent heat from state point 4 to point 1, and then changes its vapor phase back to liquid phase. In this supercritical exemplary embodiment, the efficiency of the R41 ORC system 30 is very high.

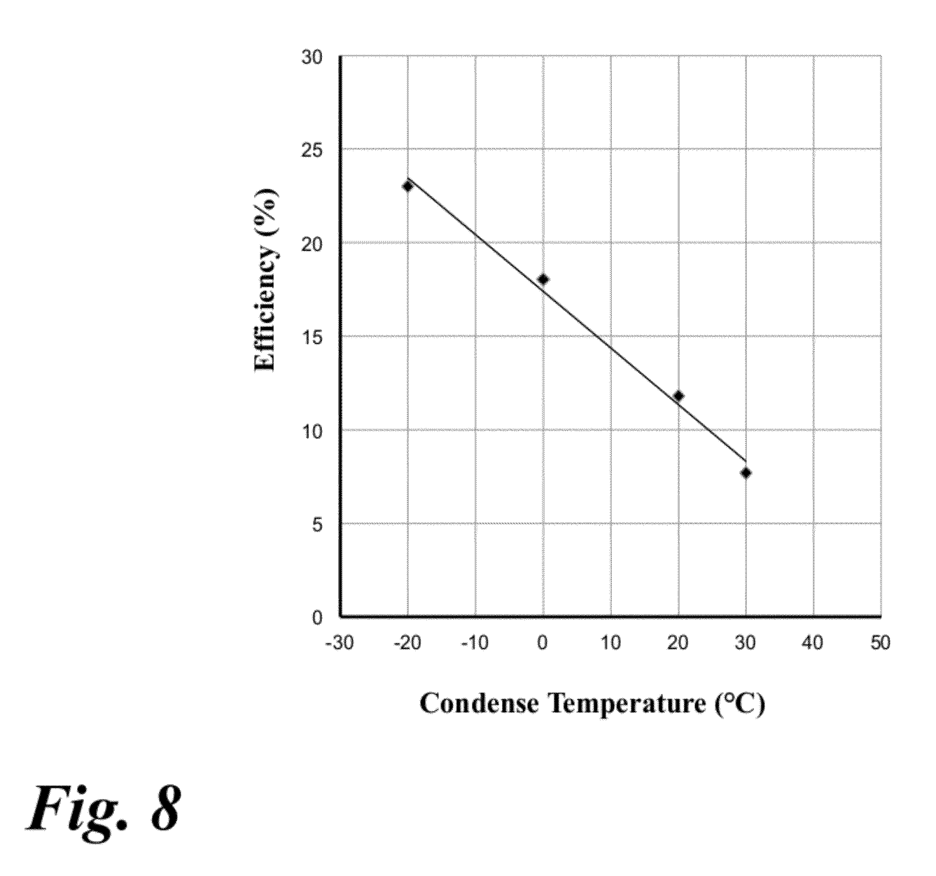

FIG. 8 is a variation of the efficiency of R41 working fluid ORC system 30 as a function of condenses temperature, with the different heating temperature. The cycle efficiency of the R41 ORC system 30 depends on the temperature of rejection in the condenser 34. The efficiency is 11.8% at the normal condense temperature (20° C.); while at the cold condense temperature (−20° C.), the efficiency will increase to 23%. It has been known that when the heat rejection is accomplished by direct air cooling in the low critical temperature hydrofluorocarbons (HFC) or hydrocarbons (HC) working fluid ORC system 30, a higher efficiency is possible at cold climate.

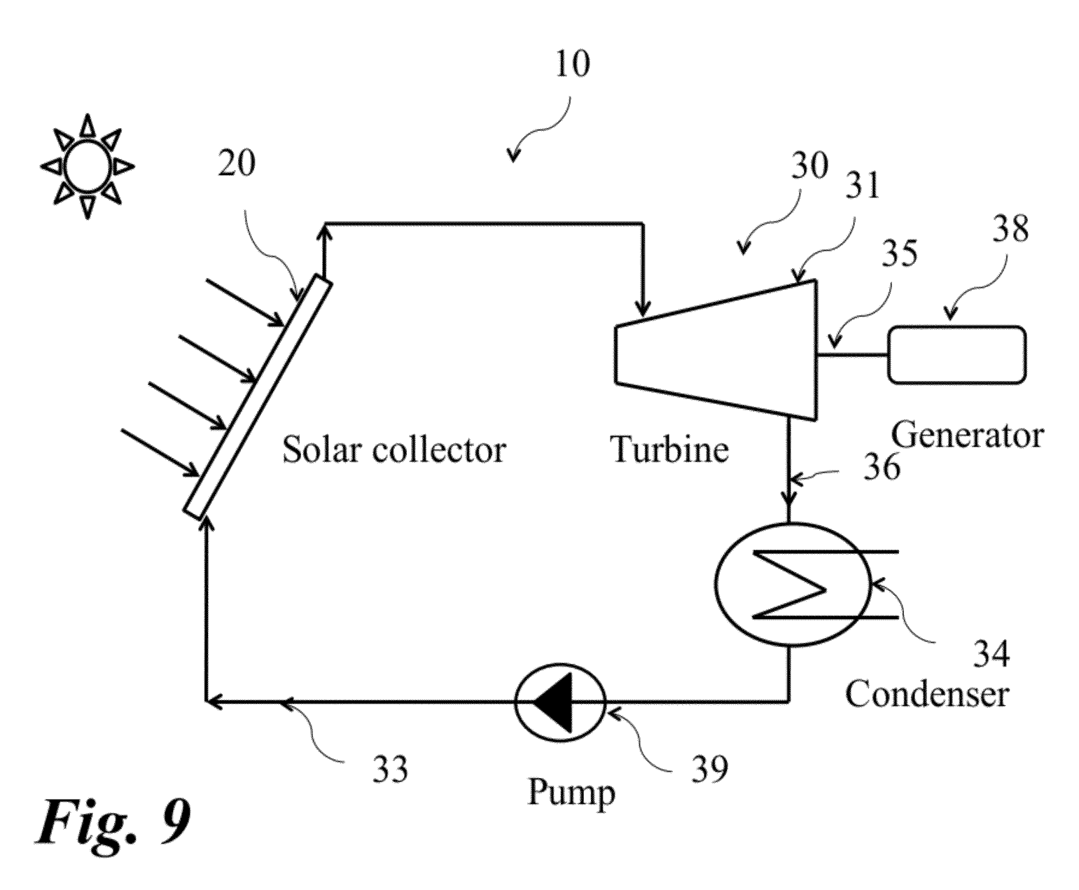

FIG. 9 shows a schematic of another low temperature organic Rankine cycle solar power system 10 with direct heating low critical temperature hydrofluorocarbons (HFC) or hydrocarbons (HC) working fluid by solar collectors 20. The solar collectors 20 and the low critical temperature HFC or HC working fluid ORC system 30 are connected for each other in one close loop. This low critical temperature HFC or HC working fluid ORC system 30 generally includes plenty of director heating solar collectors 20, a cycle pump 39; a turbine 31, a generator 38, a condenser 34, and circulation pipes 33. The HFC or HC working fluid is pumped and circulated in one closed loop of solar collectors and ORC system.

In operation of this direct heating low temperature organic Rankine cycle solar power system, the HFC or HC working fluid is pumped by the pump 39 from the condenser 34, through solar collectors 20 where it is heated by the solar energy in the closed loop. Direct heating solar collectors 20 are specially made, capable of withstanding the high working pressure. The HFC or HC working fluid is heated in the solar collectors 21 to the desired temperature and pressure, and induces a liquid phase to a high pressure vapor phase, then overheated to the desired temperature in the solar collectors, and flow to the inlet of the turbine 31. The turbine 31 is rotated by the expansion of the high pressure working fluid gas. The electrical generator 38 is coupled to the turbine so that rotation of the turbine 31 causes rotation of the generator 38. The high-pressure working fluid gas is expanded and released the high-pressure energy in the turbine, consequently reducing the temperature of the working fluid gas. The energy released during the expansion process in turbine 31 is sufficient to turn the generator 38 on shaft 35. Generator 38 uses the mechanical energy from the turbine 31 to generate electricity. The HFC or HC working fluid is condensed in the condenser 34 to induce a gas phase to a liquid phase for next cycle. Condenser 34 may reject the heat into water, which is sent to a cooling tower to release the heat to the atmosphere. Alternatively, the heat rejection may also be accomplished by directly air cooling.

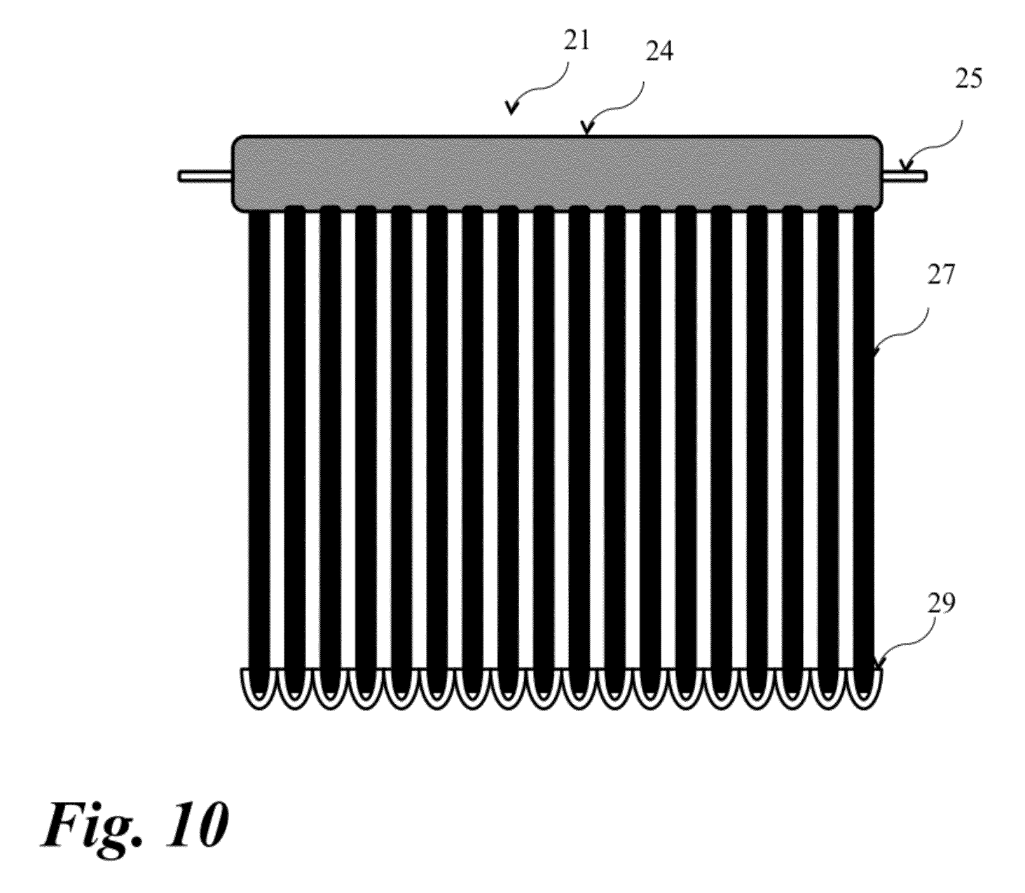

FIG. 10 shows the direct heating of solar collector 21. There are two kinds of direct heating collectors, one is modified metal-glass evacuated tube collector, and another is a full vacuum tube with direct flow pipe collector.

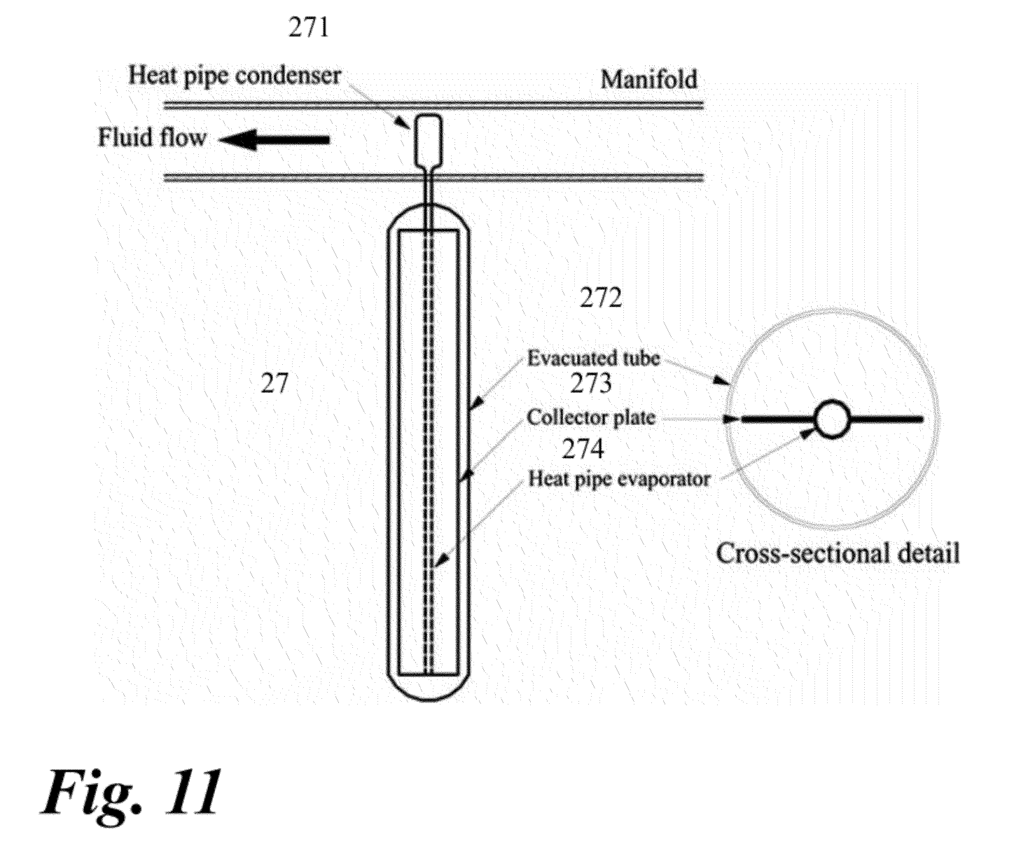

FIG. 11 is a detailed view of the modified metal-glass evacuated tube 27 connecting to the manifold. The metal-glass evacuated tubes 27 consist of a single glass evacuated tube 272. Inside the tube is a flat or curved aluminum plate 273, which is attached to a copper heat pipe 274. The aluminum plate 273 is coated with a selective surface material that absorbs solar energy well but inhibits radiative heat loss. The air is withdrawn (“evacuated”) from the space of the glass tubes to form a vacuum, which eliminates conductive and convective heat loss. These tubes 27 perform very well in overcast conditions as well as low temperatures. The manifold of this direct heating solar collector 27 is modified with strong material and special made capable of withstanding the high working pressure. These types of tubes 27 are very efficient, and are best suited to the ORC system.

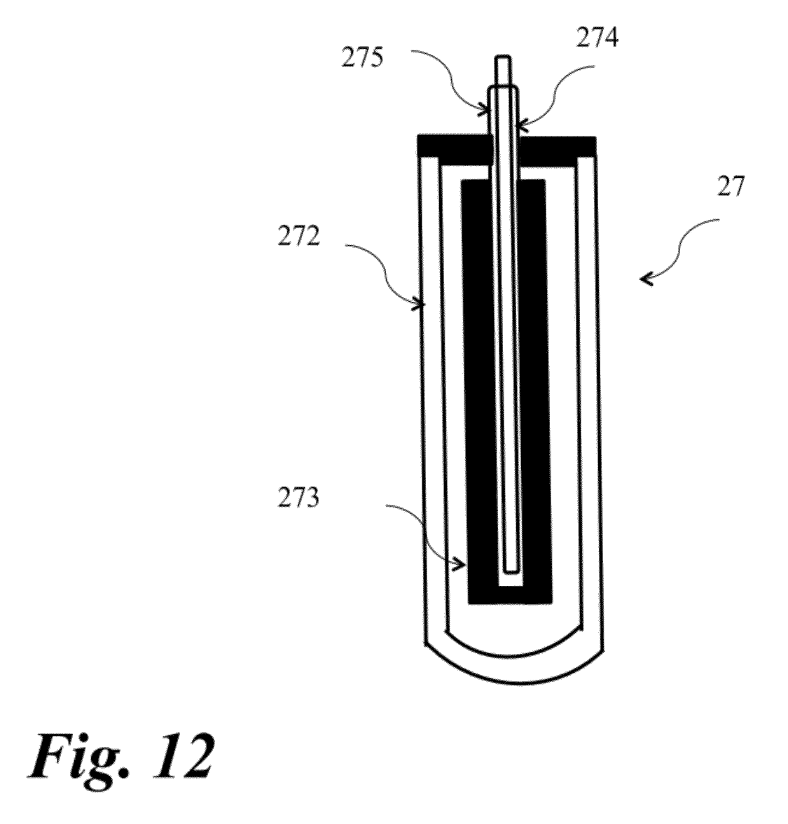

FIG. 12 is a detailed view of another direct heating solar collector, full vacuum tube with direct flow pipe collector 27. The direct flow pipe collector is composed of two modules, one is direct flow vacuum tube 272 and another one is manifold. The direct flow vacuum tube can also be called concentric double-pipe vacuum tube, which is made of glass tube 272, heat-absorb wing 273, direct flow pipe 274 and metal cover 275. The work principle of this vacuum tube is: the HFC or HC working fluid in the system flows into the inner pipe 274 which is located in the manifold from the manifold inlet, then comes into the direct flow pipe 275 along the inside pipe in the vacuum tube. In the vacuum tube, the heat-absorb wing with the selective absorption layer 273 will transfer the absorption energy to the HFC or HC working fluid, then the heated HFC or HC vapor flows out through the clearance between the direct flow pipe 274 and the inside pipe 275, to the ORC system. The flow pipe of this direct heating solar collector 27 is modified with strong material and is specially made, capable of withstanding the high working pressure. These types of direct flow pipe 27 are very efficient, and are best suited to the ORC system.

The advantages of the direct flow pipe collector: 1. The HFC or HC working fluid through the direct flow pipe gather the solar heat energy directly without heat exchanger, so the heat collecting efficiency is very high, and without the heat loss for heat exchange. 2. Because of the forced circulation of HFC or HC working fluid, the solar collector tubes can be disposal conveniently, get more energy just by rotating the vacuum tube and make it face to the sun directly. 3. Comparing to the heat-pipe collector, the direct flow pipe collectors can get a high collecting effectiveness by installing it horizontally or vertically. So it is very suitable for the veranda-installed solar ORC system, and can solve the installation problem for the high-stairs building effectively.

Due to the HFC or HC working fluid's low latent heat and low critical temperature characteristics, the low critical temperature HFC or HC working fluid ORC system 30 is able to achieve high efficiency even in cold winter with the advantages of these thermodynamic properties. This feature of the low critical temperature HFC or HC working fluid provides a potential to keep a high efficiency of this ORC system 30 in the cold winter. For example, in cold winter, the metal-glass evacuated solar collector 21 can collect solar thermal energy more efficiently in low temperature weather; the evaporation temperature could be 75° C., coupling with the cold air temperature −20° C., the efficiency of the solar collector system 20 is about 70%, and the efficiency of the R32 ORC system 30 is 27%, consequently, the total efficiency of the low temperature solar power system 10 is 18.9%. This achievable efficiency at low temperature is much high comparing to the PV or STE solar power systems.

This low temperature organic Rankine cycle solar power system 10 can range in size from 1 KW to 1000 MW; and also multiple low temperature organic Rankine cycle solar power systems can be used to form a power plant of any size. The power generated by a low temperature solar power system 10 may be used in various applications, including, but not limited to: powering commercial and residential buildings.

1. Low temperature organic Rankine cycle solar power system with low critical temperature HFC working fluid are comprising:
(I) Organic Rankine cycle system that include organic working fluid, evaporators, turbines, generators, condensers, and circulate pumps; the generators and turbines are connected with the shaft.
(II) Solar hot water collectors that include thermal storage tanks, pumps, expansion tank and plurality of solar collectors.

2. The invention of claim 1, wherein said organic Rankine cycle working fluid is selected from one of the following hydrofluorocarbons (HFC) or hydrocarbons (HC): R23 (Fluoroform), R32 (Methylenefluoride), R41 (Methylfluoride), R116 (Perfluoroethane), R125, R134a, R143a, R152a, R218 (Perfluoropropane), R227ea, R236ea, R236fa, RC318, R404A, R407A, R407B, R407C, R407D, R407E, R410A, R410B, R413A, R417A, R419A, R421A, R421B, R422A, R422B, R422C, R422D, R423A, R424A, R425A, R427A, R428A, R507A, R1150 (Ethylene), R170 (Ethane), R1270 (Propylene) R290 (Propane)

3. The invention of claim 1, wherein said, the low critical temperature hydrofluorocarbons (HFC) or hydrocarbons (HC) working fluid, which is heated in the evaporator or solar collector from a liquid phase to a gas phase, then the gas carries heat to the turbine and drives the turbine, and condensed back to the liquid phase in the condenser.

4. The invention of claim 1, wherein said the solar collectors, gather and convert solar energy to heat energy, and then transfer the heat energy to the heat transfer fluid that circulates in the solar hot water system and keeps its heat in the thermal storage tank for the ORC system.

5. The invention of claim 1, wherein said that the solar collectors that are used for the ORC systems are: flat-plate, Glass-Glass evacuated-tube and Metal-Glass evacuated-tube solar collectors, whatever the direct flow or indirect flow solar systems are.

6. The invention of claim 1, wherein said that the Glass-Glass evacuated tubes are used in a number of different configurations, including direct flow and U pipe.

7. The invention of claim 1, wherein said that the metal-glass evacuated tube solar collectors of the solar direct heating system is modified with strong material and special made capable of withstanding the high working pressure.

8. The invention of claim 1, wherein said that the direct heating solar collector, composed of concentric double-pipe vacuum tube, is modified with a strong material and specially made to be capable of withstanding the high working pressure.

9. The invention of claim 1, wherein said that the flat-plate solar collectors of the solar direct heating system further comprising of an insulated, weatherproof box containing a dark absorber plate under one or more transparent or translucent covers, is modified with a strong material and specially made to be capable of withstanding the high working pressure.

10. The invention of claim 1, wherein said that the solar heat transfer fluid, include water, anti-freezer mixtures or oils.

11. The invention of claim 1, wherein said the low temperature solar ORC can get a higher efficiency in colder climates.

12. The invention of claim 1, wherein said the low temperature solar ORC can get very high efficiency in supercritical pressure and supercritical temperature rangers.

13. The invention of claim 1, can provide solar power system ranging from 1 to 250 kW; multiple low critical temperature HFC or HC working fluid ORC systems can also be provided to form a power plant of any size over 250 kW.

14. The invention of claim 1 can provide large power plant ranging from 250 KW to 1000 MW. The power generated by low temperature organic Rankine cycle solar power plant may be used in various applications, including, but not limited to: commercial power plant and residential buildings. The invention of claim 1, can be used in conjunction with residences, office buildings, manufacturing facilities, apartment buildings, schools, hospitals, remote communications, telemetry facilities, offshore platforms, water pumping stations, desalination systems, disinfection systems, wilderness camping, headquarters installations, remote medical facilities, refrigeration systems farms and dairies, remote villages, weather stations, and air conditioning systems.

15. The invention of claim 1, wherein the turbine can be a single or multistage turbine, or any kind of expansion machine using low critical temperature hydrofluorocarbons (HFC) or hydrocarbons (HC) as working fluid.

16. An organic Rankine cycle system as claimed in claim 1, wherein the waste heat of motors, the waste heat of machines and plants, geothermal energy, ground heat energy, surface water of seas, rivers, or oceans or substances which are tempered by surface water heat energy, the geothermal potential heat energy, the heat energy from the condenser of a power station are used as a heat source to make electricity for the low temperature power system or plant.

17. An organic Rankine cycle systems as claimed in claim 1, wherein deep water of seas, rivers, or oceans or substances which are tempered by deep water, the cold air of winter, are used as cold source for the liquefaction of the low temperature power system or plant.
